(19) United States
(12) Patent Application Publication
(10) Pub. No.: US 2014/0361116 A1
(43) Pub. Date: Dec. 11, 2014

(54) PUSH-PULL CONTROL METHOD

(71) Applicant: LINCOLN GLOBAL, INC., CITY OF INDUSTRY, CA (US)

(72) Inventor: Edward A. Enyedy, Eastlake, OH (US)

(73) Assignee: LINCOLN GLOBAL, INC., City of Industry, CA (US)

(21) Appl. No.: 13/969,003

(22) Filed: Aug. 16, 2013

Related U.S. Application Data
(60) Provisional application No. 61/831,940, filed on Jun. 6, 2013.

(51) Int. Cl. B23K 9/133

(52) U.S. Cl. CPC B23K 9/1336
USPC 242/563

(57) ABSTRACT

Aspects of the innovation described herein generally pertain to methods for providing wire using two or more welding wire drive motors. The wire drive motors may be driven according to optimized power to control conveyance of the wire. A method may include modifying the power at which two or more motors operate to avoid conveying a wire under asymmetrical or excessive forces. Further, a controller may be provided to optimize the power at which at least one push motor and at least one pull motor operate to deliver wire to a welding operation.

### CROSS-REFERENCE TO RELATED APPLICATIONS

This application is based on U.S. Provisional Patent Application Ser. No. 61/831,940 filed Jun. 6, 2013 and entitled “SYSTEMS AND METHODS FOR MULTI-MOTOR BALANCING”, the disclosure of which is incorporated herein by reference.

### TECHNICAL FIELD

The disclosures herein generally relate to methods and apparatuses for controlling two or more motors for feeding welding wire. More particularly, the subject innovation is directed toward feeding welding wire at a speed while controlling the power of two or more motors in reference to one another.

### BACKGROUND OF THE INVENTION

Many welding applications utilize a consumable wire electrode commonly referred to as welding wire. As welding techniques become more sophisticated, wire may be provided continuously through a welding torch (or “gun”) utilizing various wire feeder technologies.

When feeding welding wire through particular guns, over distance or at angles in field environments, or utilizing welding wire with low column strength (like aluminum) a “push-pull” system may be used. One motor may be located in the welding gun and is used to pull the wire from the source to the gun. The second motor may be located remotely, such as at the wire feeder where the wire supply is stored, and may be used to push the wire from the source to the gun. The second motor may also be located directly at the supply of electrode wire, or it may be in-line with the welding gun.

Based on the parameters required for a welding operation, operator preference or skill, or other factors, it may be desired to feed the wire at a particular speed such that a certain amount of wire is provided from the feeder over a period of time. One or more wire feeding motors may be controlled to ensure the wire is fed at the desired speed.

Because no two motors are exactly alike, a variety of motor types and control methods have been used to maintain the speed of electrode wire. The differences in motors may cause one motor to feed wire with a greater power than the other. This may cause the wire to incur additional stress in the form of tension or compression, and may also cause wear on the motors if the action of one causes resistance to the other.

### SUMMARY OF THE INVENTION

In accordance with the present invention, there is provided a method for providing wire for a welding operation. The method may include conveying a wire using at least a first motor and a second motor, determining a first motor power of the first motor, determining a second motor power of the second motor and detecting an excessive force in the wire. The method may adjust at least one of the first motor power and the second motor power based at least in part on the excessive force in the wire.

In accordance with the present invention, there is provided a method for controlling a push motor and a pull motor in a wire feeding system. The method may include detecting a wire speed of a consumable electrode, comparing the wire speed to a reference speed, detecting a first motor power at which a first motor is operating, and detecting a second motor power at which a second motor is operating. The method may modify at least one of the first motor power and the second motor power based at least in part on a difference between the wire speed and the reference speed to arrive at a optimized total power, wherein the optimized total power is the lowest sum of the first motor power and the second motor power that conveys the consumable electrode at the reference speed.

In accordance with the present invention, there is provided a controller for managing a push motor and a pull motor in a wire feeding system. The controller may include a push motor control module configured to manage power output of a push motor, a pull motor control module configured to manage power output of a pull motor, a wire speed module configured to receive a measured wire speed, and an optimization module configured to manage the power output of at least the push motor and the pull motor to deliver a wire at a reference speed at an optimized first motor power and an optimized second motor power.

These and other objects of this invention will be evident when viewed in light of the drawings, detailed description, and appended claims.

### BRIEF DESCRIPTION OF THE DRAWINGS

The above and/or other aspects of the invention will be more apparent by describing in detail embodiments of the invention with reference to the accompanying drawings, in which:

FIG. 1 illustrates a flow chart of a methodology for optimizing the power from two or more wire driving motors;

FIG. 2 illustrates a flow chart of an alternative methodology for optimizing the power from two or more wire driving motors;

FIG. 3 illustrates a flow chart of another alternative methodology for providing wire feeding at a desired speed while optimizing wire drive motor power;

FIGS. 4-6 illustrate a flow chart of a methodology for controlling a push motor and a pull motor for wire feeding;

FIG. 7 illustrates a diagrammatical schematic representation of a system for wire feeding at a desired speed utilizing optimized total motor power;

FIG. 8 illustrates a diagrammatical schematic representation of a system for wire feeding at a reference speed while optimizing the power of the push motor and the pull motor;

FIG. 9 illustrates a diagrammatical schematic representation of a controller for managing motors in a wire feeding welding system;

FIGS. 10A and 10B illustrate graphs visually depicting multiple states of power in two motors and their sum total power to arrive at an optimized power state for wire feeding;

FIGS. 11A and 11B illustrate graphs visually depicting the total power of two wire feeding motors over several control states; and

FIG. 12 illustrates a graph visually depicting motor power and wire feed speed.

### DETAILED DESCRIPTION OF THE INVENTION

Embodiments of the invention will now be described below by reference to the attached figures. The described embodiments are intended to assist the understanding of the invention, and are not intended to limit the scope of the invention in any way. Like reference numerals refer to like elements throughout.

Various welding operations may use a “wire gun,” or welding torch that receives a consumable electrode in the form of wire via a wire feeder or other wire source. To conduct the welding operation, wire is provided at a defined wire speed. The wire speed provides the consumable electrode at a specified rate. In some welding operations, wire speed may be at the discretion of the operator or permitted to occur at varying speeds. In other welding operations, a particular speed may be preferred or even necessary to provide the appropriate amount of material during the welding operation.

As used herein, a “reference speed” is the speed at which the wire is intended to travel according to the welding operation or operator preference. Thus, if the wire speed is different from the reference speed, the system may adjust parameters to increase or decrease the wire speed to convey the wire at the reference speed. One or more reference speeds may be stored according to operations or operators, and new reference speeds may be entered or provided. In embodiments, the reference speed may be changed on-the-fly during operation (or at any other time such as start-up), and techniques herein may thereafter adapt to optimize the system at least in part according to the new or changed reference speed.

The wire speed may be measured according to a length of wire per unit of time, but it is unnecessary to track such aspects according to a specific system. For example, volume melted, weight provided, and other metrics involving more than the one-dimensional length of a portion of wire may be considered. In embodiments, wire speed may be measured according to one or more methods, to include use of an encoder. Rotary mechanisms, machine vision, weight change measurements, storage change measurements (e.g., decreasing diameter of wire spool) may all be employed to determine or corroborate other determinations of wire speed.

The wire speed is, at least in part, a function of motor power. Wire drive motors may push or pull (or perform both functions) to convey wire toward a welding operation. Each wire drive motor operates at a motor power. Embodiments herein may have two or more wire drive motors for conveying wire across a distance from a source to its consumable use as an electrode. The power of one or more motors is measured according to various techniques and in various units for storage or use in calculations.

Welding systems operate according to system parameters. Parameters may include wire speed, wire type, current and other electrical parameters for the welding operation, and so forth. These parameters may be changed at a power supply, wire feeder, welding gun, or other components to provide the desired endstate in a welding operation performing as intended. In embodiments, parameters may be adapted based on available resources (e.g., adapt a welding operation to non-specified wire size, adapt a welding operation in view of lower or higher power electrical supply than specified).

Failure to calibrate motor power in a consumable electrode welding system may cause the wire to undergo excessive forces during operation at one or more wire speeds. Excessive forces include tension and compression that degrade system performance. In embodiments, torsion may also be a consequence of a push motor power and pull motor power being incompatible. Degradation to system performance may include buckling, stretching, twisting, or other deformation to the wire such that the wire is not continuously fed according to the set parameters. One cause of excessive forces can include one wire drive motor “over-driving” the system, whereby its forces attempt to convey the wire at a faster speed than one or more other wire drive motors are conveying the wire. Alternatively, one or more motors may under-drive the system, resisting the efforts of one or more other motors to convey the wire at the reference speed. This can place stresses on the wire as it is stretched or compressed, and may reduce the controllability of the motors as one or more motors may be resisting another.

As used herein, a “force threshold” is a proportion of a force required to cause at least partial failure or yielding in the wire. In embodiments, a force threshold can be a percentage of the force that causes a wire to stretch or buckle. Force thresholds are thus different for different wires, but relate to the wire's Young's modulus and other physical constants. A force threshold can be, for example, 80% of a force that causes a wire to stretch. In an alternative or complementary embodiment, a force threshold can be 50% of a force that causes the wire to buckle. In other embodiments, the force threshold can be 100% of a force required to stretch or buckle the wire. Various embodiments herein can also permit dynamic force thresholds that vary over time or through process iterations (e.g., when calibrating wire drive motors on the fly, force threshold decreases from a first adjustment to a second adjustment).

“Normal forces,” as used herein, include operating envelopes that do not create a significant statistical risk of degraded system performance due to strains on the wire or stresses on other components. In embodiments, normal forces are those forces that are below or inside a corresponding force threshold. Further, a wire in-process can vary in- and out-side of force thresholds. In at least one embodiment, the wire is still usable and no performance degradation occurs if it remains under excessive force for less than a defined period of time. Thus, the time periods at various force thresholds or under measured forces can be identified and stored for use. In an example embodiment, a force threshold can be 120% of a force that stretches a wire for 15 seconds.

For purposes of at least efficiency and minimizing excessive forces on the wire, a wire can be conveyed with an “optimized total power” whereby the wire is conveyed with the minimum sum of the power of all motors functioning to convey the wire. For example, in a system with one push motor and one pull motor, the power of both motors can be added, and the power level of each where the sum is lowest is the optimized total power. It is understood that the optimized total power may vary depending on reference speed, welding application, wire specifications, and so forth. Various terms related to sums or composites can be used to indicate calculated amounts based on two or more values herein.

The optimized total power is related to optimized power for each respective motor. Optimized power can be detected or calculated based on the forces on the wire (measured or theoretical) along with the parameters of the welding operation including wire speed.

While aspects herein are described at various phases of operation, it is appreciated that the techniques disclosed may be conducted on-the-fly, in production, and/or during normal operation of a welding apparatus. No preexisting information is necessary, and it is not required (but also not prohibited) that a welding apparatus enter a calibration phase to optimize wire drive motor power.

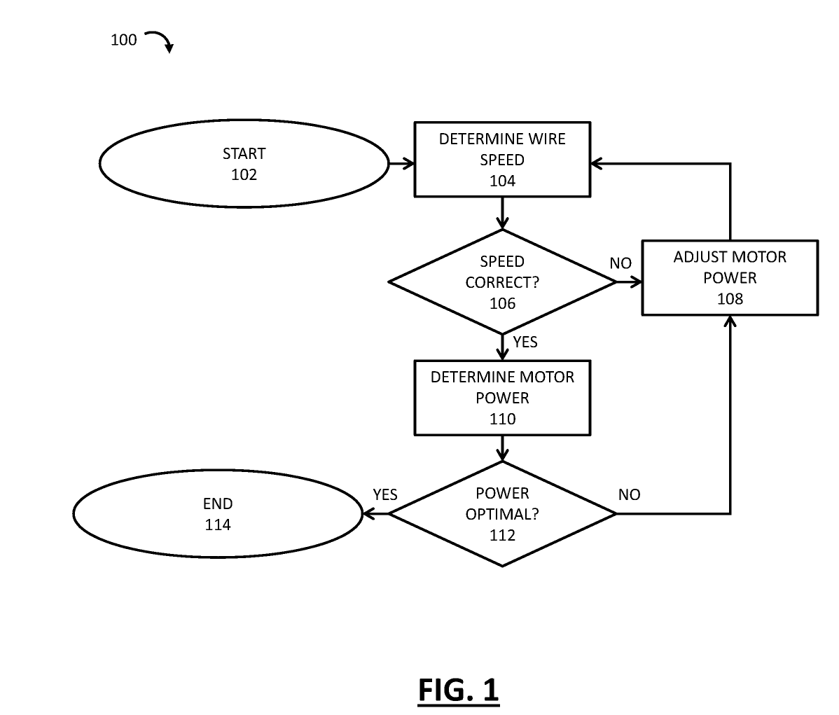

FIG. 1 illustrates a flow chart of a methodology 100 for optimizing the power from two or more wire driving motors. Methodology 100 begins at 102 and proceeds to 104 where the wire speed is determined.

After determining the wire speed, methodology 100 proceeds to 106 where an evaluation is made as to whether the speed is correct. If the speed is incorrect, methodology 100 may proceed to 108 where the motor power of one or both motors is adjusted to increase or decrease the wire speed.

If the wire speed is determined to be correct, the power of each motor is measured at 110. After determining the power of the two or more wire driving motors, the motor power of one or both motors is compared at 112 to determine if they are optimized. If the motor power is not optimized, methodology 100 recycles to 108 where the motor power is adjusted. Because the speed was previously indicated to be correct, the higher-powered motor may have its power decreased while the lower-powered motor may have its power increased to maintain the speed of the wire while optimizing motor power.

Methodology 100 may repeat one or more loops whereby motor power of one or more motors is adjusted at 108 until the wire speed is at the correct value for the operation or according to the operator's preference, and until the two or more motors are operating at a substantially optimized total power to reduce stress on the wire. This provides a resource-efficient operation of the wire device(s) that reduces power consumption, wire breakage or deformation, and unnecessary wear on motors and other components. At 114, methodology 100 ends.

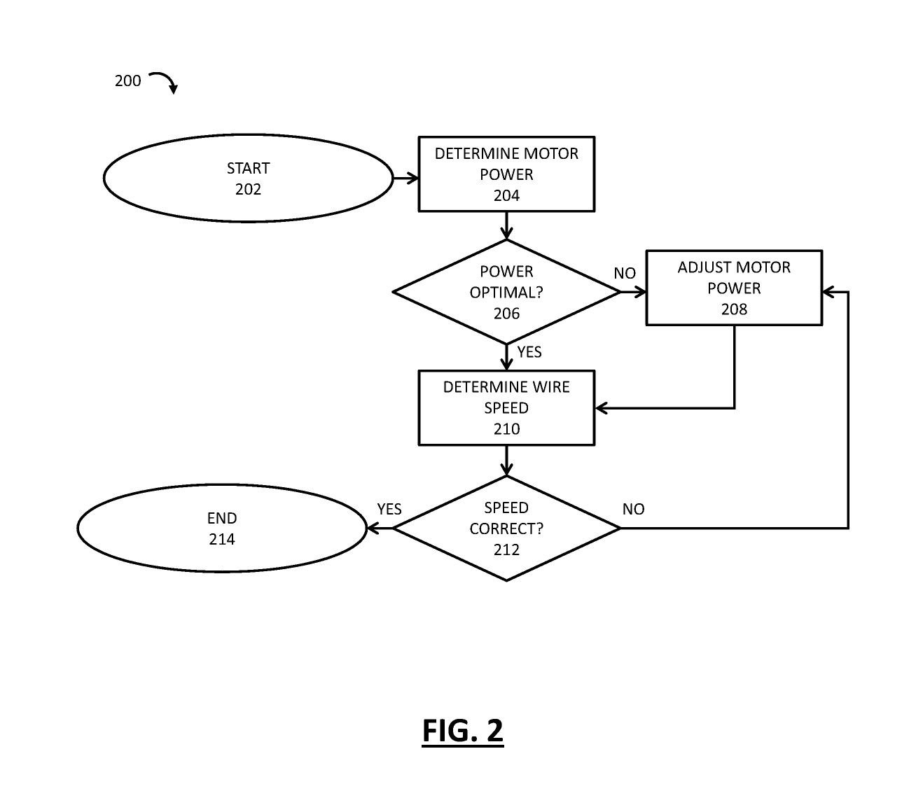

Turning now to FIG. 2, illustrated is an embodiment of a methodology 200 for optimizing the power from two or more wire driving motors. Methodology 200 is similar to methodology 100 except that it interrogates the power of two or more wire driving motors prior to performing a wire speed evaluation.

Methodology 200 begins at 202 and proceeds to 204 where the operating power of each of the two or more wire driving motors is determined.

After determining the respective motor power, methodology 200 proceeds to 206 where an evaluation is made as to whether the motor power of each motor is operating at a respective optimal power (e.g., to minimize total overall power between all motors). If the motor power of one or more motors is not optimized, methodology 200 may proceed to 208 where the motors are adjusted to optimize their power. For example, a lower-powered motor may have its power increased, or a higher-powered motor may have its power decreased. In embodiments, a summation of each power can be evaluated to determine whether a summation of the power of the motors is optimized.

If the motor power of each motor is determined to be optimized, the wire speed is measured at 210. The measured speed may be compared to a desired speed based on operator preference or operation parameters. If the speed is not equal to the desired speed, methodology 200 recycles to 208 where the power of one or more motors is adjusted. Because the motor power was previously optimized, the motor power of all motors may be increased or decreased together to retain optimal motor power while adjusting wire speed.

Methodology 200 may repeat one or more loops whereby the motor power of one or more motors is adjusted at 208 until the two or more motors are operating at an optimized total power to reduce stress on the wire, and until the wire speed is at the correct value for the operation or according to the operator's preference. This provides a resource-efficient operation of the wire device(s) that reduces power consumption, wire breakage or deformation, and unnecessary wear on motors and other components. At 214, methodology 200 ends.

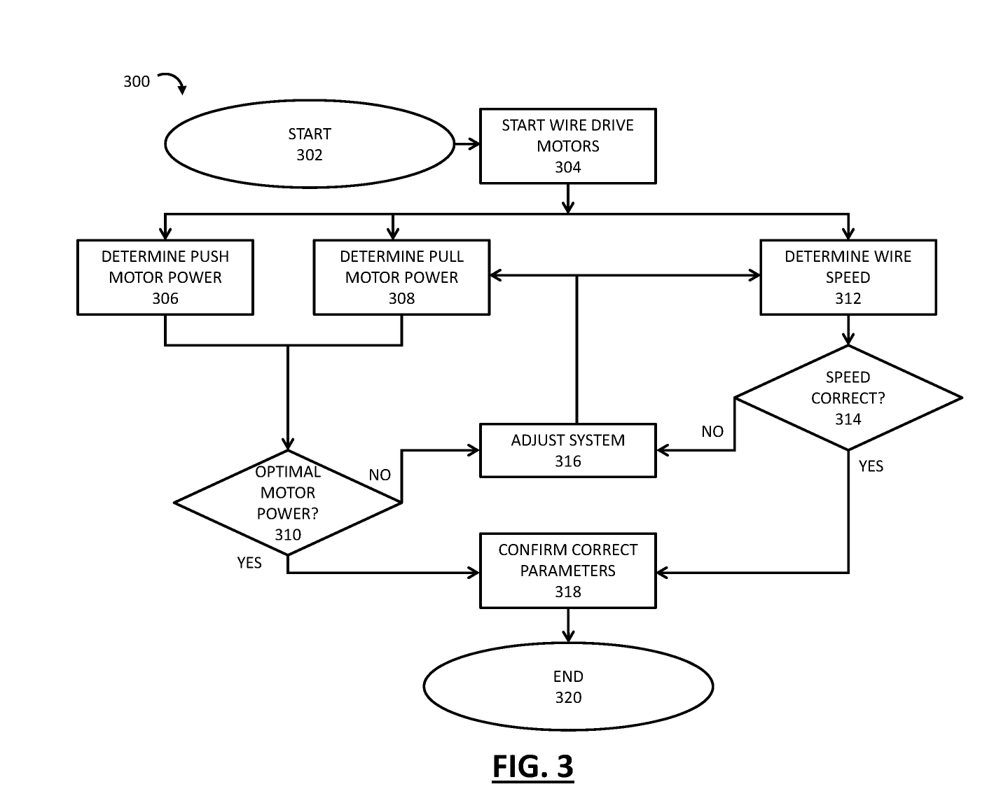

FIG. 3 illustrates an example embodiment of a flow chart of a methodology 300 for providing wire feeding at a desired speed while minimizing total motor power. Methodology 300 includes a parallel comparison operation whereby multiple determinations may be made simultaneously to adjust the system to a specification.

Methodology 300 begins at 302 and proceeds to 304 and 312. In a first branch of methodology 300, at 306, the push motor power is determined, and this branch of methodology 300 simultaneously proceeds to 308 where a pull motor power is determined. In embodiments, the determinations at 306 and 308 may be performed in an order rather than simultaneously (e.g., first measuring one power and thereafter measuring another at the same or different components).

After the push motor power and pull motor power have been determined, this branch of methodology 300 proceeds to 310 where the push motor power and pull motor power are compared. If the push motor power and pull motor power are determined to be not optimized at 310, methodology 300 may proceed to 316 where the system is adjusted to optimize the power of one or both motors.

Simultaneously, using the same or different physical and/or logical components, the branch of methodology 300 proceeding through 312 evaluates the speed of the wire being fed by the push motor and the pull motor. At 314, a determination is made as to whether the speed of the wire is correct when compared to a reference speed. If the wire speed is incorrect, methodology 300 may proceed to 316 where the system is adjusted to bring the wire speed to the reference speed.

When the push motor power and pull motor power are optimized and the wire is travelling at the reference speed, both determinations 310 and 314 will return positive, and methodology 300 may proceed to 318 where the parameters related to both speed and power are confirmed correct. Thereafter, methodology 300 ends at 320.

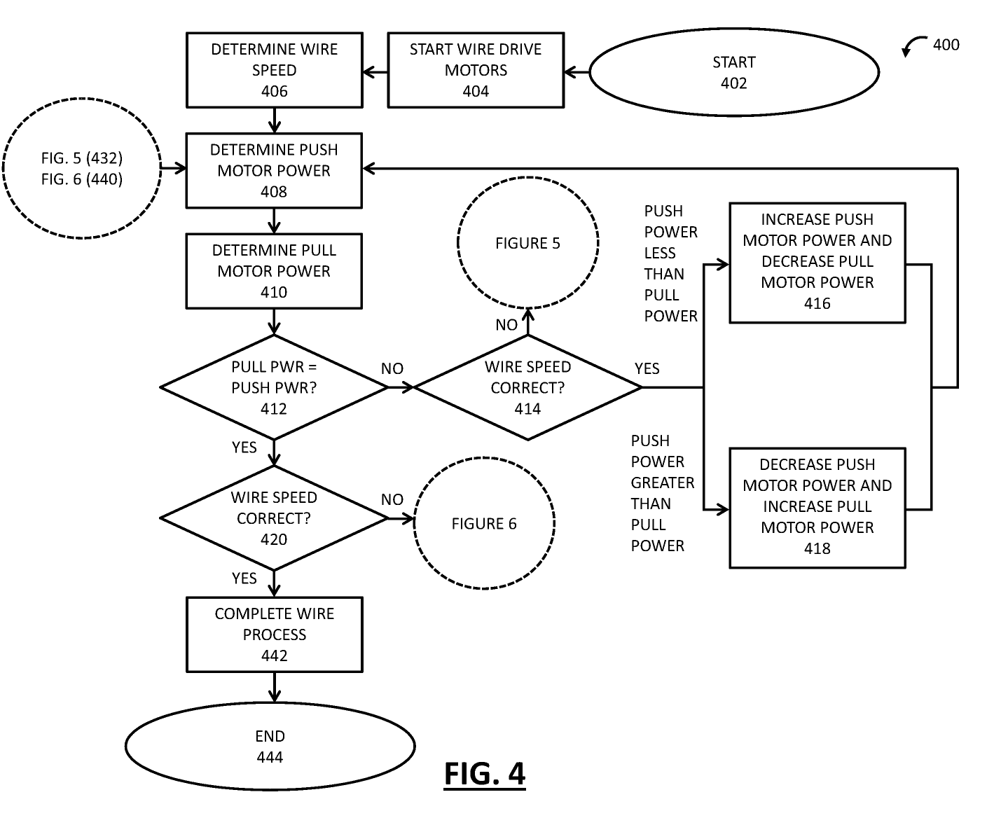

Turning now to FIGS. 4-6 illustrated is an example embodiment of a flow chart of a methodology 400 for controlling a push motor and a pull motor for wire feeding. Methodology 400 depicts, for purposes of illustration, an embodiment where the optimal power (e.g., neither the push motor nor pull motor over-drives or under-drives the wire operation) occurs when the push motor power and pull motor power are equal. However, it is to be understood that the optimal values of each respective wire drive motor may be unequal, and that the optimal power may further be a dynamic value that changes over time. However, for purposes of illustration of one possible embodiment, methodology 400 depicts a technique whereby power of the wire drive motors is optimized by comparing each wire drive motor power in reference to another to substantially equalize the power of all motors.

Methodology 400 starts at 402 and proceeds to energize the wire drive motors. Once the push motor and pull motor are operating in a current state (e.g., both at substantially constant power), the wire speed may be determined at the current state.

At 408, a push motor power is determined, and at 410 a pull motor power is determined. In alternative embodiments, the respective power of each energized motor may be discovered in opposite order (e.g., pull before push) or simultaneously. Further, embodiments may facilitate continuous monitoring of wire drive motors.

After determining the power of the push motor and the power of the pull motor at 406 and 408, methodology 400 may proceed to 412 where the power of the push motor and the power of the pull motor are compared. Comparison of the actual power of each wire drive motor, or to another power (e.g., optimized power) can be identified or stored as a respective power comparison. Methodology 400 then proceeds to two branches depending on whether the push and pull motors are operating at optimal power. Both branches require a determination of whether the wire is travelling at the appropriate speed.

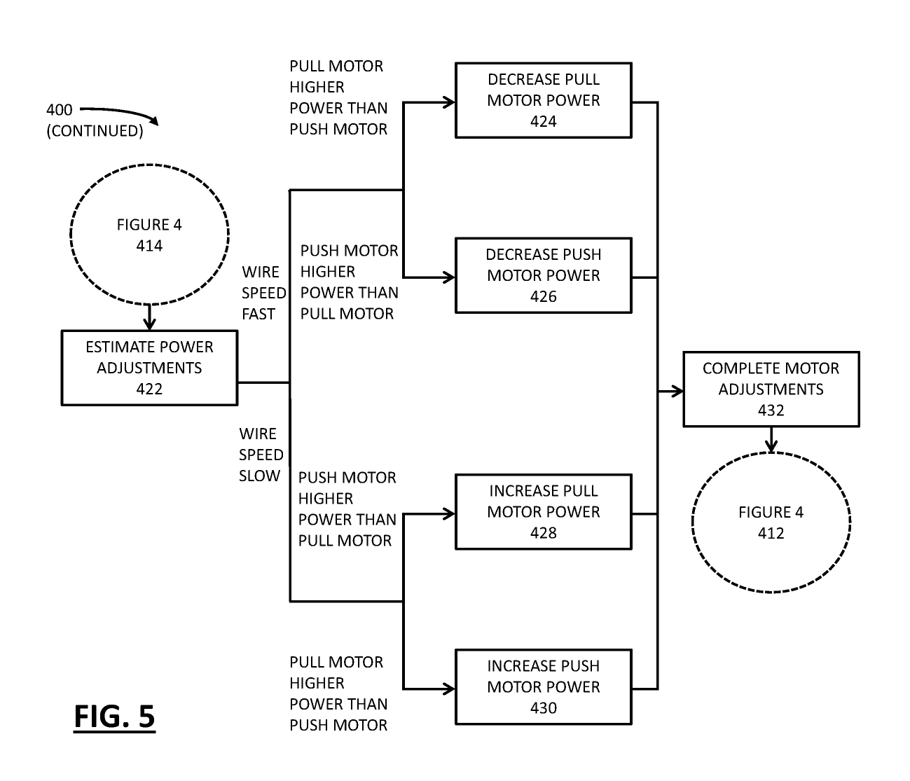

If the push motor power is not equal to the pull motor power, methodology 400 proceeds to 414 where a determination is made as to whether the wire is travelling at the reference speed for the operation. If the wire is not travelling at the reference speed, methodology 400 proceeds to 422 (FIG. 5).

As noted throughout this disclosure, substantially equal power between the push motor and pull motor (e.g., as at 412) is one possible embodiment for optimized motor power. In embodiments, the power of the push motor and the power of the pull motor may be within a predefined or dynamic range of one another, or each may have separately described optimized power. In one or more embodiments, a threshold power difference (e.g., number of power units, percentage, other calculation) can be determined to define a range of operating power for one or both motors. In one or more embodiments, specific values can be determined for optimized motor power independent from other motors. Different optimization parameters may apply to different wire speeds or operations. Further, in embodiments, the optimized power may change over time based on sensor feedback, user input, or other information. Thus, the interrogation comparing the push power and pull power at 412 is intended not to be limiting, but rather to present one possible embodiment for illustrative purposes. Where multiple optimization evaluations occur (e.g., one of each motor), it is appreciated that methodology 400 may branch through additional paths or steps.

If the wire is travelling at the reference speed, methodology 400 branches again depending on whether the push motor or the pull motor is operating at higher power. If the push motor power is greater than the pull motor power, the push motor power may be decreased while the pull motor power is increased at 418. On the other hand, if the pull motor power is greater than the push motor power, the pull motor power may be decreased while the push motor power is increased at 416. By offsetting decreased power in one motor by increasing it in the other, the correct wire speed may be maintained.

After adjusting the motor power at 416 or 418, methodology 400 may recycle to 408 where the operating parameters are monitored for reevaluation after adjustment.

If the wire speed is determined to differ from the reference speed at 414, methodology 400 proceeds to 422 (FIG. 5) where the power adjustments to be made are evaluated. In embodiments, the aspect of 422 may be omitted; however, this aspect is included in FIG. 5 to invoke calculative processes that may be performed to determine the amount of change to a motor required to modify speed, as well as facilitate transition between FIGS. 4 and 5. In embodiments, estimation of power adjustments as at 422 may occur between other steps as well (e.g., after 412, after 414 when the wire is travelling at the reference speed, and elsewhere).

After 422, methodology 400 branches depending on whether the wire is travelling faster than the reference speed or slower than the reference speed. If the wire is travelling faster than the reference speed, methodology 400 again branches based on which wire drive motor is operating at higher power (as it was determined at 412 that the drive motors are operating at unequal power). If the wire speed is faster than the reference speed and the pull motor is operating at higher power than the push motor, at 424 the pull motor power may be decreased to equalize the pull motor power with the push motor power while slowing the wire speed to the reference speed. If the wire speed is faster than the reference speed and the push motor is operating at higher power than the pull motor, at 426 the push motor power may be decreased to equalize the push motor power with the pull motor power while slowing the wire speed to the reference speed.

If the wire is travelling slower than the reference speed, methodology 400 branches based on which wire drive motor is operating at higher power (as it was determined at 412 that the drive motors are operating at unequal power). If the wire speed is slower than the reference speed and the pull motor is operating at higher power than the push motor, at 428 the pull motor power may be increased to equalize the pull motor power with the push motor power while speeding up the wire to the reference speed. If the wire speed is slower than the reference speed and the push motor is operating at higher power than the pull motor, at 430 the push motor power may be increased to equalize the push motor power with the pull motor power while speeding up the wire to the reference speed.

After completing the changes at one of 424-430, methodology 400 may proceed to 432 where the motor adjustments are completed and the operation returns to a substantially stable state (e.g., while the drive motor power of at least one motor and/or wire speed is different than prior to adjustments, the motors are again operating at substantially constant power and wire is again moving at substantially constant speed). Thereafter, methodology 400 returns to 412 (FIG. 4) where the operating parameters may be re-evaluated to determine if further adjustments are required and/or confirm the operation is occurring according to the optimization. In embodiments, the aspect of 432 may be omitted; however, this aspect is included in FIG. 5 to describe the transition period between the signal for an adjustment and its completion, as well as facilitate transition between FIGS. 5 and 4.

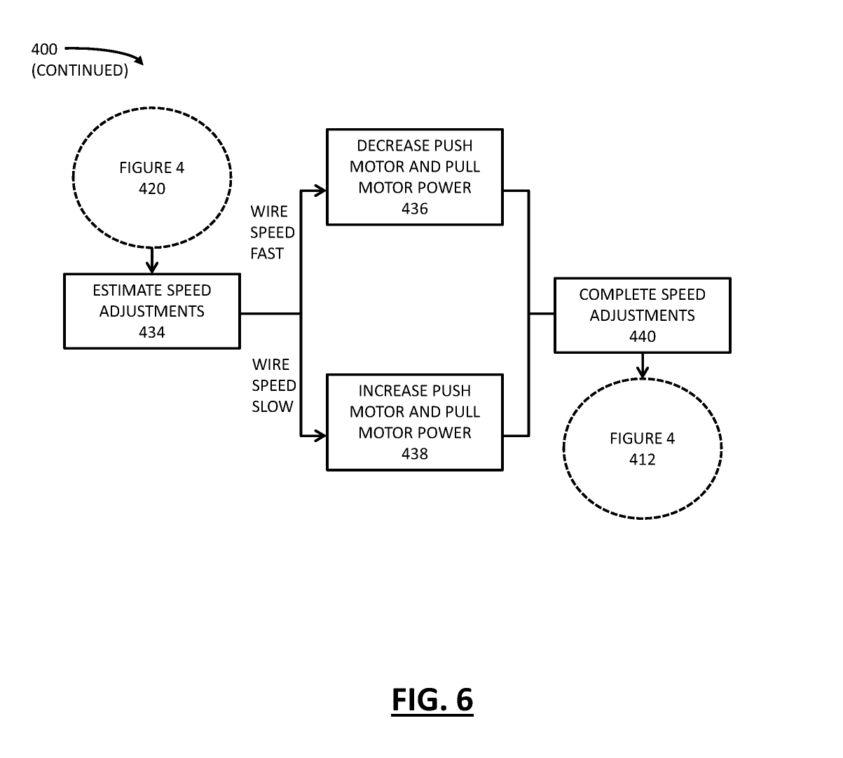

If methodology 400 determines the push motor power and pull motor power are substantially equal at 412, methodology 400 may compare the wire speed from 406 to the reference speed at 420. If the wire speed is determined to be incorrect at 420, methodology 400 may proceed to 434 (FIG. 6) where the speed adjustments to be made are evaluated. In embodiments, the aspect of 434 may be omitted; however, this aspect is included in FIG. 6 to invoke calculative processes that may be performed to determine the amount of change to a motor required to modify speed, as well as facilitate a clearly illustrated transition between FIGS. 4 and 6. In embodiments, estimation of speed adjustments as at 434 may occur between other steps as well (e.g., after 414 and elsewhere).

After 434, methodology 400 branches depending on whether the wire speed is travelling slower or faster than the reference speed. If the wire speed is faster than the reference speed, the drive motors may have their power decreased equally to maintain parity between the respective operating power (or power outputs) of the push motor and the pull motor (as it was determined at 412 that the drive motors are operating at substantially equal power) while slowing the wire speed to the reference speed. If the wire speed is slower than the reference speed, the drive motors may have their power increased equally to maintain parity between the respective operating power of the push motor and the pull motor (as it was determined at 412 that the drive motors are operating at substantially equal power) while speeding up the wire to the reference speed.

After completing the changes at 436 or 438, methodology 400 may proceed to 440 where the motor adjustments are completed and the operation returns to a substantially stable state (e.g., while the drive motor power of at least one motor and/or wire speed is different than prior to adjustments, motors are again operating at substantially constant power and wire is again moving at substantially constant speed). Thereafter, methodology 400 returns to 412 (FIG. 4) where the operating parameters may be re-evaluated to determine if further adjustments are required and/or confirm the operation is occurring according to the optimization. In embodiments, the aspect of 440 may be omitted; however, this aspect is included in FIG. 6 to describe the transition period between the signal for an adjustment and its completion, as well as facilitate transition between FIGS. 6 and 4.

Once it is determined that the power of the push motor and pull motor are equalized, and the wire speed is correctly travelling at the reference speed, the welding operation may be conducted until 442, where the process including wire feeding is completed. Upon completion of the process at 442, methodology 400 may end at 444. In embodiments, during 442 or at 444, the wire drive motors may be de-energized and the system may be shut down.

While the embodiment described sets forth using the higher-powered motor as a reference point from which to adjust, it is also understood that the lower-powered motor may be used as a reference when adjusting in accordance with the aspects of FIG. 5 and other portions here. Further, while it is suggested that calculation be conducted using instantaneous values and reference requirements, it is also within the scope of aspects herein that statistical values such as averages or medians be employed when adjusting motor power or other operating parameters.

Further, it is appreciated that methodology 400 may be performed by evaluating the power of each respective wire drive motors before measuring the wire speed. While all branches of the methodology employ both metrics, it is possible to modify the order of evaluation (e.g., as indicated by at least some of the differences between FIGS. 1 and 2). In embodiments, aspects of methodology 400 may be performed simultaneously. Finally, it is additionally understood that methodology 400 provides but one embodiment among many possible methodologies, and is not intended to be an exhaustive or exclusive indication of the only or even a preferred method for implementing aspects herein.

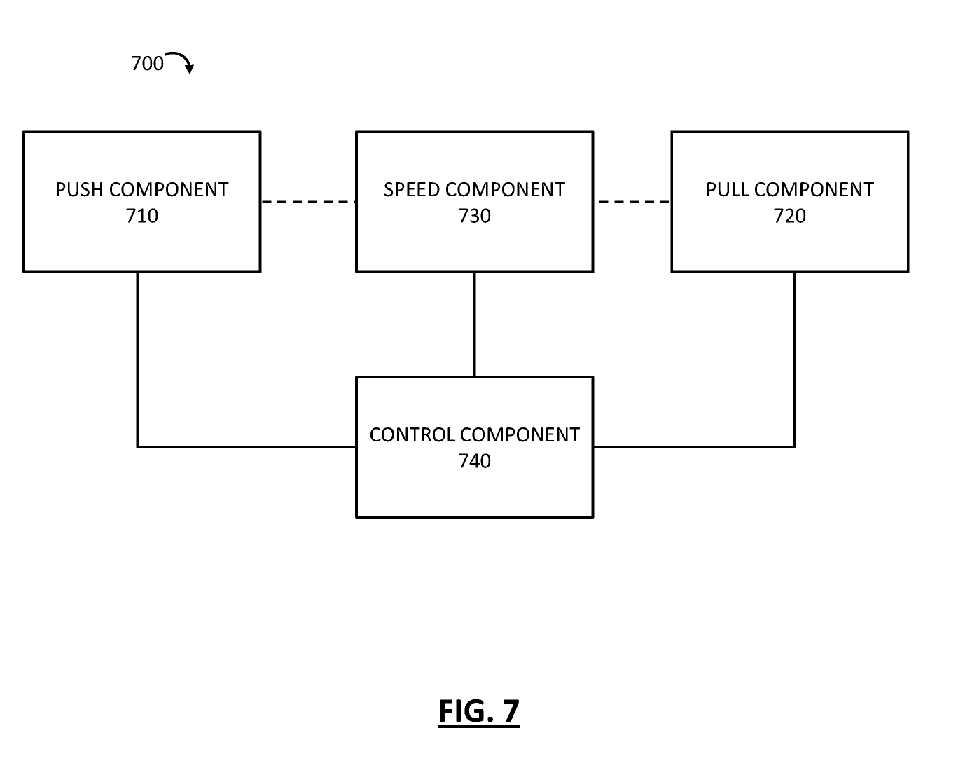

Turning now to FIG. 7, illustrated is an example block diagram of an embodiment of a system 700 for wire feeding at a desired speed utilizing a minimum total motor power. System 700 may include push component 710, pull component 720, speed component 730, and control component 740.

Push component 710 may include means for pushing a wire from a wire source to a point where it is consumed in a welding operation. Push component 710 may further include various control, monitoring, and communication means to facilitate changes to the operating parameters of push component 710. This may include increasing or decreasing the energy or rate applied to wire pushed by push component 710, as well as reporting and/or storing information about operation and performance.

In embodiments, push component 710 may be a wire feeder including an integral wire source and one or more wire pushing motors. The wire feeder may be a single, dual, or multiple wire feeder, integrating connections to one or more wire guns and supplying welding currents according to the parameters required by the respective guns.

Speed component 730 may include means for measuring the speed of a wire being provided in a welding operation. In an embodiment, speed component 730 may be an encoder. In alternative or complementary embodiments, speed component 730 may include various rotation-per-time (e.g., of a spool of the source, of a known-size wheel rotated by passing wire) components, speed measuring optics, speed calculators based on the mass of wire changing location over time, and/or other components for determining a speed at which the wire is travelling through system 700 and being consumed in the welding operation. Speed component 730 may (but need not be) located at push component 710, pull component 720, or there between. In embodiments, speed component 730 may include multiple distributed components (e.g., two speed gauges at two points in system 700 to corroborate speed calculations or provide a back-up).

Speed component 730 may further include various control, monitoring, and communication means to facilitate measuring, storing, and/or transmitting the wire speeds. In embodiments, parameters of speed component 730 may be modified to improve measuring performance (e.g., speed calculation accuracy and/or precision, time required to render speed calculation), adjust to different parameters of the welding operation(s) (e.g., different wire diameter, changes in lighting, different materials), and so forth.

Pull component 720 may include means for pulling a wire from a wire source to a point where it is consumed in a welding operation. Pull component 720 may further include various control, monitoring, and communication means to facilitate changes to the operating parameters of pull component 720. This may include increasing or decreasing the energy or rate applied to wire pulled by pull component 720, as well as reporting and/or storing information about operation and performance.

In embodiments, pull component 720 may be a welding gun including pulling means to pull a wire from a source, alone or as assisted by a push motor at or near the source. Various embodiments of system 700 may have the pulling means integrated within the welding gun or maintained externally nearby, as a detachable module, and so forth.

Control component 740 receives information from at least push component 710, pull component 720, and speed component 730 to provide control for system 700 such that the power of push component 710 and power of pull component 720 are optimized to minimize stresses and optimize efficiencies in system 700 (e.g., minimize tension or compression on the wire being fed, reduce wear to push component 710 and pull component 720, reduce energy usage of push component 710 and pull component 720).

In operation, control component 740 may increase or decrease the power of push component 710 and/or pull component 720 to accelerate or decelerate the wire to a reference speed in accordance with welding operation or operator parameters. Speed component 730 provides feedback regarding the speed of the wire in relation to the reference speed. While adjusting the speed of the wire, or independent thereof, control component 740 may also modify the power of one or both of push component 710 and pull component 720 to optimize the power of these components. In an embodiment, the power of push component 710 and the power of pull component 720 may be optimized when the sum power of both is minimized. In alternative or complementary embodiments, the power of push component 710 and the power of pull component 720 may be optimized when the power of each is equal. In embodiments, equal power between both push component 710 and pull component 720 at a minimum sum power may be the optimal power.

In embodiments, one or more of the components of system 700 may include wired or wireless communication means. Various embodiments may include mixed communication means (e.g., both wired and wireless communication means, communication means employing different specifications, and others). Further, in embodiments, one or more components of system 700 may include memories and/or processors for storing and/or processing data in accordance with aspects herein.

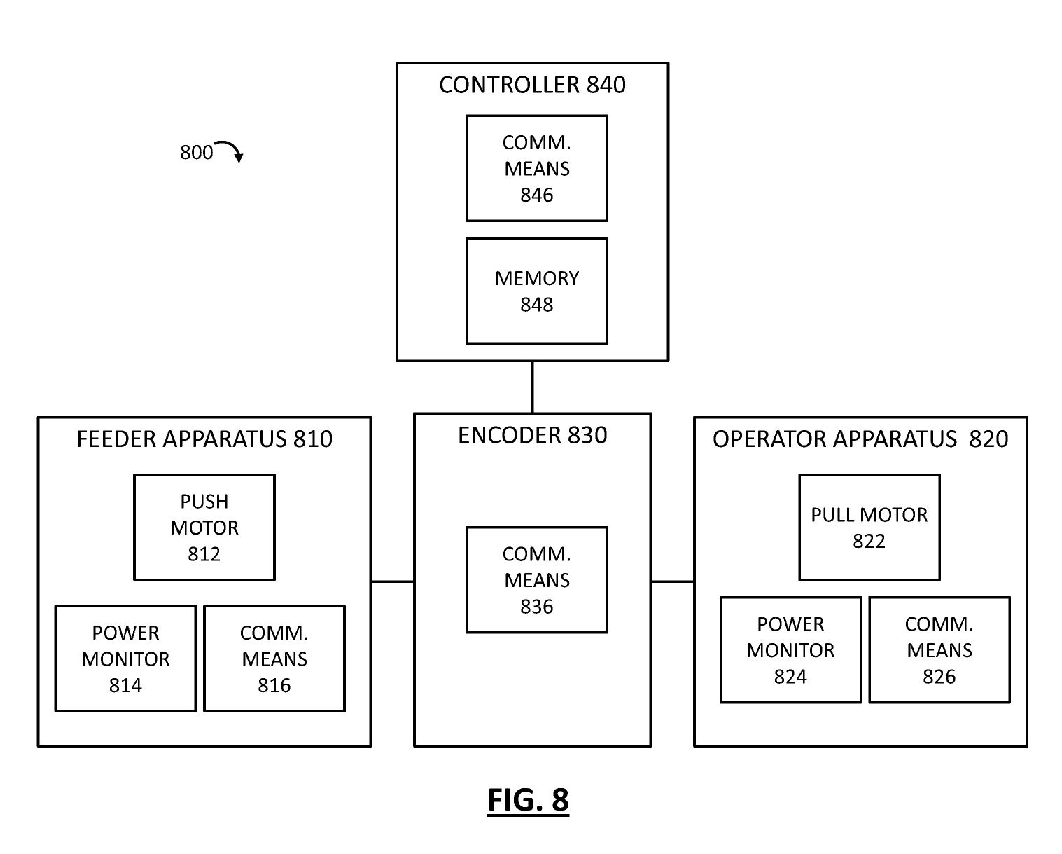

Turning now to FIG. 8, illustrated is an example block diagram of an embodiment of a system 800 for wire feeding at a reference speed while optimizing the power of the push motor and the pull motor. System 800 may include feeder apparatus 810, operator apparatus 820, encoder 830, and controller 840.

Feeder apparatus 810 may include means for pushing a wire from a wire source to a point where it is consumed in a welding operation. Feeder apparatus 810 may further include various control, monitoring, and communication means to facilitate changes to the operating parameters of feeder apparatus 810. This may include increasing or decreasing the energy or rate applied to wire pushed by feeder apparatus 810, as well as reporting and/or storing information about operation and performance.

Feeder apparatus 810 may include push motor 812, power monitor 814, and communication means 816. Push motor 812 may facilitate conveying wire from a wire source. In embodiments, push motor 812 pushes wire forward toward a wire gun. Push motor 812 may cause a wire spool to turn and release wire for use. In alternative or complementary embodiments, an additional spool motor may be included in feeder apparatus 810 to assist with unwinding the wire from a spool wire source.

Power monitor 814 may be used to determine the operating power of at least push motor 812. The operating power may be stored, displayed, or transmitted to other components as an instantaneous or aggregated value. In embodiments, communication means 816 may be employed to transmit at least information from power monitor 814 to other components of system 800.

Communication means 816 may also be configured to receive control signals. For example, communication means 816 may receive a signal (e.g., at least in part from controller 840) the increase or decrease push motor 812 power or conveyance speed. Feeder apparatus 810 may include a control circuitry operatively coupled with communication means 816 to modify various operating parameters. In addition to local input (e.g., changes directly to feeder apparatus 810, changes using a feeder apparatus 810 interface), remote input may be received, processed, and executed using communication means 816.

In embodiments, feeder apparatus 810 may be a wire feeder including an integral wire source and one or more wire pushing motors. The wire feeder may be a single, dual, or multiple wire feeder, integrating connections to one or more wire guns and supplying welding currents according to the parameters required by the respective guns.

Encoder 830 may provide means for measuring the speed of a wire being provided in a welding operation. In various embodiments, encoder 830 may be associated with various rotation-per-time (e.g., of a spool of the source, of a known-size wheel rotated by passing wire) components, speed measuring optics, speed calculators based on the mass of wire changing location over time, and/or other components for determining a speed at which the wire is travelling through system 800 and being consumed in the welding operation. Encoder 830 may (but need not be) located at feeder apparatus 810, operator apparatus 820, or there between. In embodiments, encoder 830 may include multiple distributed components (e.g., two speed gauges at two points in system 800 to corroborate speed calculations or provide a back-up).

Encoder 830 may include communication means 836. Communication means 836 facilitates transmission and reception of signals by encoder 830 at least to and from other components of system 800. In at least one embodiment, instantaneous or aggregated readings from encoder 830 may be transmitted to other components of system 800 using communication means 836. In embodiments, communication means 836 may receive instructions for execution by encoder 830 (e.g., turn on, turn off, change parameters).

Encoder 830 may further include various control, monitoring, and communication means to facilitate measuring, storing, and/or transmitting the wire speeds. In embodiments, parameters of encoder 830 may be modified to improve measuring performance (e.g., speed calculation accuracy and/or precision, time required to render speed calculation), adjust to different parameters of the welding operation(s) (e.g., different wire diameter, changes in lighting, different materials), and so forth.

In embodiments, encoder 830 may be integrated with another component of system 800. For example, encoder 830 may be located in or otherwise operatively coupled with one or more subcomponents of feeder apparatus 810 or operator apparatus 820. In embodiments, there may be more than one encoder 830, and two or more encoder 830 devices may be used to collect the same or different data at multiple points within system 800 (e.g., one in feeder apparatus 810, one in operator apparatus 820).

Operator apparatus 820 may include means for pulling a wire from a wire source to a point where it is consumed in a welding operation. Operator apparatus 820 may further include various control, monitoring, and communication means to facilitate changes to the operating parameters of operator apparatus 820. This may include increasing or decreasing the energy or rate applied to wire pulled by pushing component 820, as well as reporting and/or storing information about operation and performance.

Operator apparatus 820 may include pull motor 822, power monitor 824, and communication means 826. Pull motor 822 may facilitate receiving wire from a wire source at operator apparatus 820. In embodiments, pull motor 822 pulls wire forward to a wire gun. Pull motor 822 may cause a force onto a wire that may assist to remove (e.g., unspool) lengths of wire from a source or supply. Pull motor 822 may be located near components causing the wire to be consumed in a welding operation.

Power monitor 824 may be used to determine the operating power of at least pull motor 822. The operating power may be stored, displayed, or transmitted to other components as an instantaneous or aggregated value. In embodiments, communication means 826 may be employed to transmit at least information from power monitor 824 to other components of system 800.

Communication means 826 may also be configured to receive control signals. For example, communication means 826 may receive a signal (e.g., at least in part from controller 840) the increase or decrease pull motor 822 power or conveyance speed. Operator apparatus 820 may include a control circuitry operatively coupled with communication means 826 to modify various operating parameters. In addition to local input (e.g., changes directly to operator apparatus 820, changes using a operator apparatus 820 interface), remote input may be received, processed, and executed using communication means 826.

In embodiments, operator apparatus 820 may be a welding gun including pulling means to pull a wire from a source, alone or as assisted by push motor 812 at or near the source. Various embodiments of system 800 may have the pulling means integrated within the welding gun or maintained externally nearby, as a detachable module, and so forth.

Controller 840 receives information from at least feeder apparatus 810, operator apparatus 820, and encoder 830 to provide control for system 800 such that the power of feeder apparatus 810 and the power of operator apparatus 820 are optimized to minimize stresses and optimize efficiencies in system 800 (e.g., minimize tension or compression on the wire being fed, reduce wear to feeder apparatus 810 and operator apparatus 820, reduce energy usage of feeder apparatus 810 and operator apparatus 820). In embodiments, controller 840 may perform or enable one or more methodologies herein (or variants thereof and alternatives thereto) to optimize the operating power of two or more motors.

Controller 840 may include at least communication means 846 and memory 848. Communication means 846 may receive information from at least other components of system 800, as well as transmit information and/or instructions to at least other components of system 800. Memory 848 may store instructions or logic to perform various aspects described herein, as well as operating data, component information, and other data related to the operation and control of system 800.

In operation, controller 840 may increase or decrease the power of feeder apparatus 810 and/or operator apparatus 820 (or modify other operating parameters of system 800) to accelerate or decelerate the wire to a reference speed in accordance with welding operation or operator parameters. Encoder 830 provides feedback regarding the speed of the wire in relation to the reference speed. While adjusting the speed of the wire, or independent thereof, controller 840 may also modify the power of one or both of feeder apparatus 810 and operator apparatus 820 to optimize the collective power of these components. In an embodiment, the power of feeder apparatus 810 and the power of operator apparatus 820 may be optimized when the sum power of both is minimized. In alternative or complementary embodiments, the power of feeder apparatus 810 and the power of operator apparatus 820 may be optimized when the power of both is equal. In embodiments, equal power between both feeder apparatus 810 and operator apparatus 820 at a minimum sum power may be the optimal power.

In embodiments, the communication means of one or more of feeder apparatus 810, encoder 830, operator apparatus 820, and/or controller 840 may include wired or wireless communication means. Various embodiments may include mixed communication means (e.g., both wired and wireless communication means, communication means employing different specifications, and others). Further, in embodiments, one or more components of system 800 may include memories and/or processors for storing and/or processing data in accordance with aspects herein.

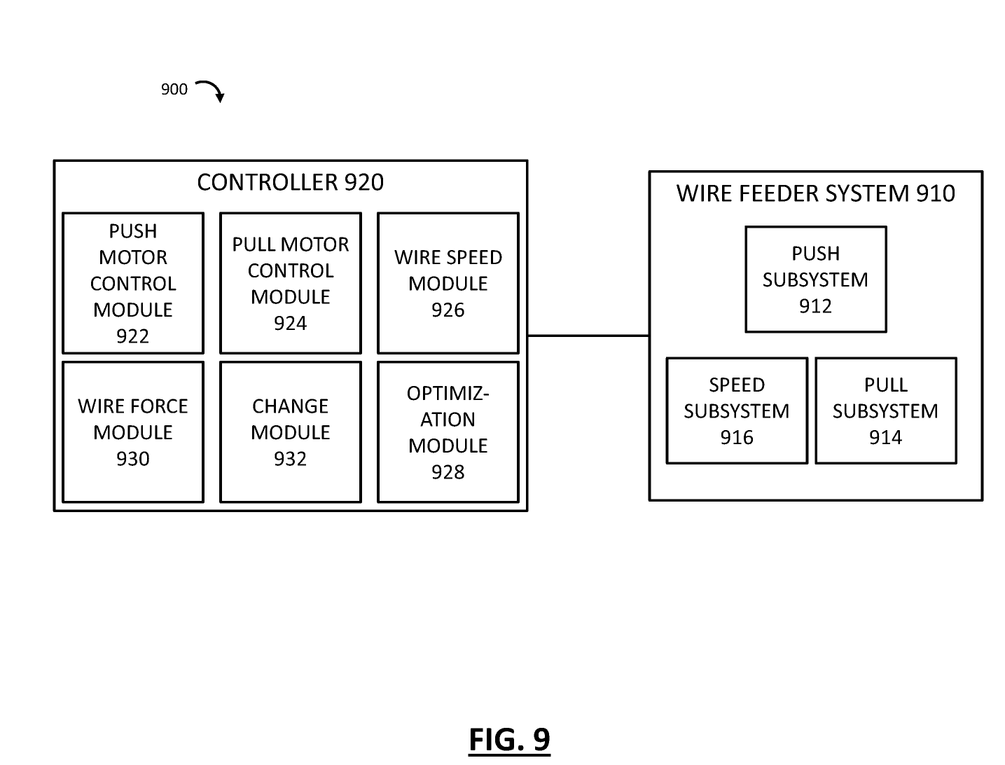

Turning now to FIG. 9, illustrated is a diagrammatical schematic representation of a controller 920 for managing motors in a wire feeding welding system 900. System 900 may include wire feeder system 910 used for conveying wire to a welding operation. Wire feeder system 910 may include push subsystem 912, pull subsystem 914, and speed subsystem 916 for at least conveying the wire and transmitting feedback regarding conveyance of the wire to controller 920.

Controller 920 may include push motor control module 922, pull motor control module 924, wire speed module 926, and optimization module 928. Controller 920 may further include wire force module 930 and change module 932. Push motor control module 922 and pull motor control module 924 may control at least the power(s) at which one or more of push subsystem 912 and pull subsystem 914 operate. Wire speed module 926 may receive and process information about the wire speed from at least speed subsystem 916, and/or control parameters relating to the operation of speed subsystem 916.

Optimization module 928 may receive information from and leverage push motor control module 922, pull motor control module 924, and wire speed module 926 to optimize operation of at least wire feeder system 910 such that push subsystem 912 and pull subsystem 914 convey the wire at a optimized push motor power and pull optimized motor power respectively. The optimized push motor power and optimized pull motor power may be discovered (e.g., through multiple iterations of feedback adjustments to wire feeder system 910) or calculated (e.g., operational models or statistics employed based on welding operation parameters) and applied to push subsystem 912 and pull subsystem 914 using at least push motor control module 922 and pull motor control module 924 respectively.

Controller 920 may further include wire force module 930. Wire force module 930 may detect forces on a wire being conveyed by wire feeder system 910. For example, wire force module 930 may detect excessive forces in embodiments. In alternative or complementary embodiments, wire force module 930 detects normal forces to confirm the wire is being conveyed under forces that are not excessive. Wire force module 930 may use one or both of physical measurements and theoretical calculations to detect or determine tension, compression, or other excessive forces on the wire. Information from wire force module 930 can be provided to at least optimization module 928 to be used in calculating or effecting optimized motor power or modifying other parameters of system 900.

Controller 920 may further include change module 932. Change module 932 may receive or identify information regarding changes to a welding operation effected at least in part using system 900. For example, changes may include changes to the type of welding operation being performed, the welding tool being used, wire material, wire thickness, wire speed, and so forth. Change module 932 may receive or identify changes which may be passed to optimization module 928 to be used in calculating or effecting optimized motor power or modifying other parameters of system 900.

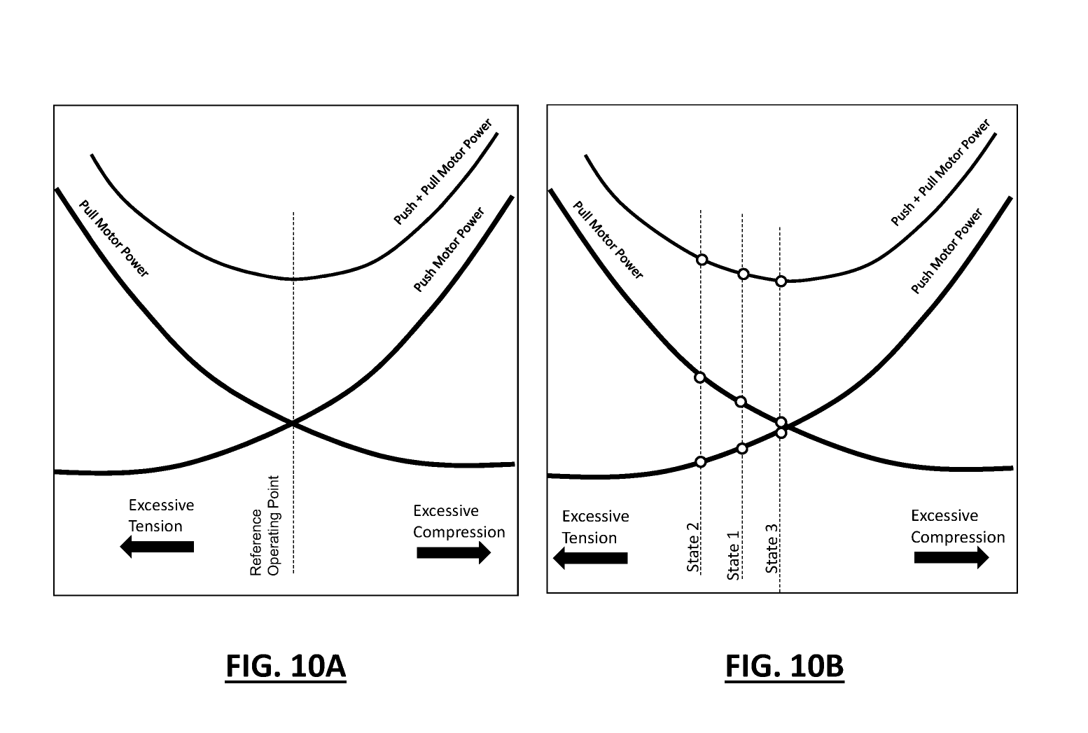

Turning now to FIGS. 10A and 10B, illustrated are representative graphs depicting the adjustments between multiple states to arrive at a reference operating point or reference operating range. Aspects herein comprise controlling two or more motors for feeding welding wire. The control may be based on monitoring the power of both motors. The reference operating point to the motors may be determined by the lowest amount of total motor power. The reference operating point may be the wire between the motors avoiding both excessive tension and compression.

For example, in an embodiment, the pull motor may be operating at 5 Watts, and the push motor may be operating at 6 Watts, for a total system power of 11 Watts. If the pull motor is overdriving the system and placing the wire in excessive tension, the pull motor power may increase to 11 Watts while the push motor power drops to 3 Watts. Total system power is 14 Watts. If the push motor is overdriving the system and placing the wire in excessive compression, the pull motor power may decrease to 4 Watts and the push motor power increase to 10 Watts. Total system power is 14 Watts.

Thus, FIG. 10A shows a reference operating point whereby the sum of the power of two wire drive motors is minimized. FIG. 10B shows a plurality of operating states (e.g., State 1, State 2, State 3) that a system or method as described herein may transition through in corrective iterations to arrive at the reference operating point or reference operating range.

As shown in FIG. 10B, a system or method may begin in State 1 where the wire is in excessive tension. An initial correction to State 2 or other change to the system that increases the pull motor power may place the wire further into tension. Recognizing that the pull motor is overdriving the operation, the subsequent correction to State 3 may bring the operation into a minimum-power state in which the wire experiences neither excessive tension nor compression. In State 3, the push motor power and pull motor power are not precisely equal, but are substantially equal.

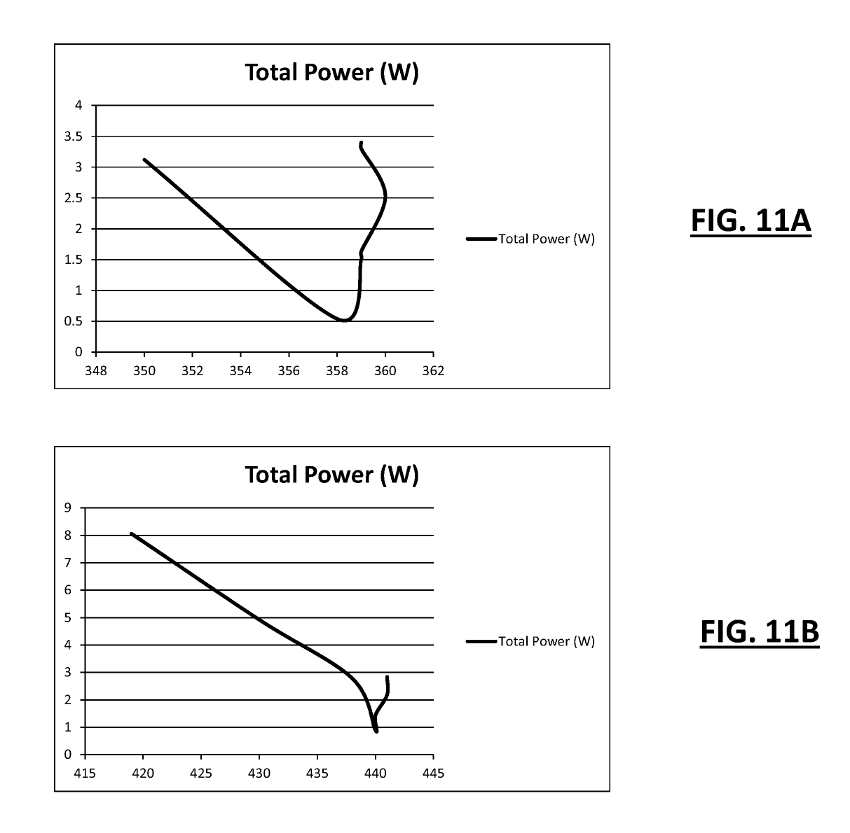

Turning now to FIGS. 11A and 11B, illustrated are graphs depicting total power in a system of two or more wire drive motors through a plurality of states. FIGS. 11A and 11B illustrate how, by modifying operating parameters, systems may be calibrated to a reference operating state minimizing total power between two or more wire driving motors.

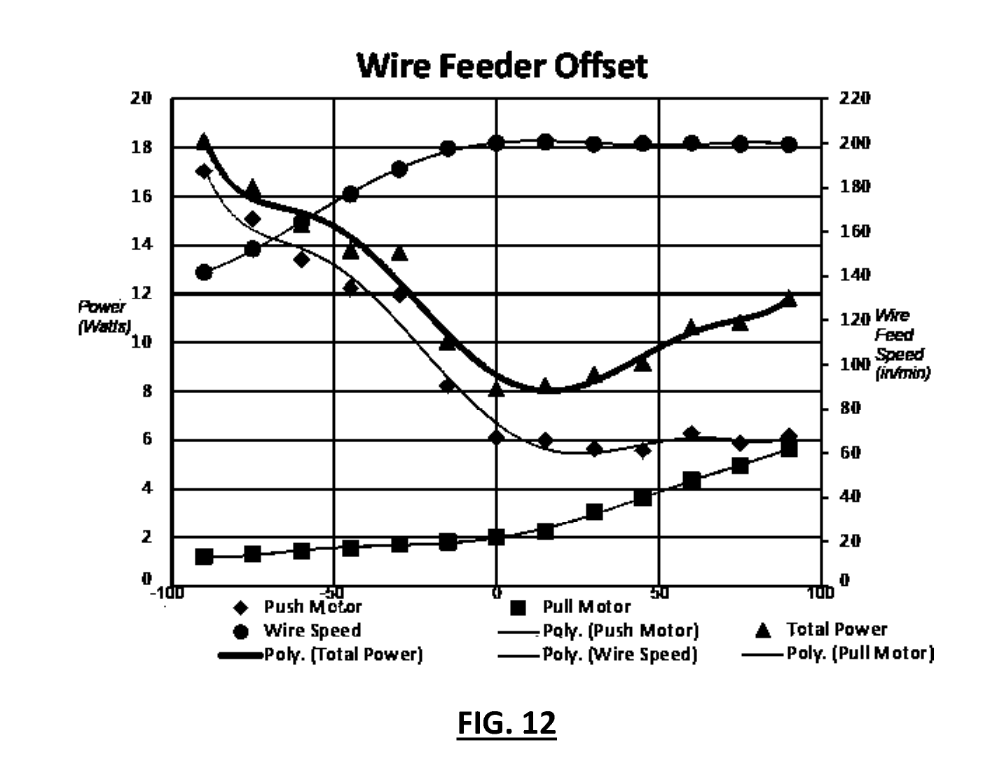

FIG. 12 illustrates a graph showing the wire speed corresponding with the push motor power, pull motor power, and total power. As shown, the power of the push motor and the power of the push motor can approximately converge or come to an approximate operating range such that total power is minimized. Total power or individual motor power can vary as required to maintain the desired wire speed when reached depending on feedback from the control systems.

In the embodiment depicted, a wire can be conveyed at constant tension by setting the wire feeder or other components to a tension setting. For example, a Lincoln Electric® Python® can be set to a tension setting of 2 (or another pre-programmed value), which results in a specific tension or range of tension being maintained during use. In embodiments, tension settings can be based on, for example, one or more motors, wire characteristics, welding operation and so forth. The control system can adjust power to achieve a wire speed of 200 inches per minute at the desired tension or within the acceptable tension range.

While aspects herein are directed toward balancing the power of two or more motors, embodiments additionally include those setting motor power to arbitrary or specifically optimized power values. For example, a power bias can be applied such that, during or after the lowest combined power or balanced power is found, one motor is run at a bias percentage or bias value greater or less than the other. In some embodiments, the pull motor can be run at ten percent greater power than the pull motor. Different proportions (e.g., five percent, fifteen percent) or total power different (two watts, four watts) can be applied. In embodiments, the bias can be a positive bias wherein one of the push motor or pull motor is run at a greater power than the other. Alternatively, the bias can be a negative bias wherein one of the push motor or pull motor is run at less power than the other. In still other embodiments, both motors can be adjusted (e.g., pull motor power increased and push motor power decreased) after optimized operating parameters are developed through techniques herein.

A bias power can be applied to one or more motors to modify or refine operation or function of one or more motors. A bias power can be applied to a motor to more consistently maintain wire speed, reduce malfunctions, decrease stresses or compensate for changes in another motor, and so forth. In one example, a positive bias power can be applied to the pull motor to reduce the likelihood of the wire deflecting between the push motor and the pull motor. In another example, a positive bias power can be applied to the pull motor to compensate for overheating or damage in the push motor. In still another embodiment, a positive bias power can be applied to one of the push motor or the pull motor to avoid constant adjustments to maintain a desired wire speed.

Although the innovation has been described as minimizing the sum of the power between a push motor and a pull motor, it is to be appreciated that alternative optimizations (e.g., target power of one or more motors, target difference between power of two or more motors) may be accomplished in accordance with the control mechanisms described herein.

While the invention has been directed to systems and methods predominantly related to wire feeding techniques employing one pull motor and one push motor, those of ordinary skill in the art will appreciate how such aspects can be applied to a third motor, or systems with three or more motors, in accordance with the disclosures herein.

While the invention has been particularly shown and described with reference to embodiments thereof, the invention is not limited to these embodiments. It will be understood by those of ordinary skill in the art that various changes in form and details may be made therein without departing from the spirit and scope of the invention as defined by the following claims.

What is claimed is:

1. A method for providing wire for a welding operation, comprising:
conveying a wire using at least a first motor and a second motor;
determining a first motor power of the first motor;
determining a second motor power of the second motor;
detecting a force threshold in the wire; and
adjusting at least one of the first motor power and the second motor power based at least in part on the force threshold in the wire.

2. The method of claim 1, further comprising:
measuring a wire speed;
comparing the measured wire speed to a reference speed; and
adjusting at least one of the first motor and the second motor to substantially equalize the wire speed to the reference speed.

3. The method of claim 2, wherein adjusting at least one of the first motor power and the second motor power is further based at least in part on a difference between the measured wire speed and the reference speed.

4. The method of claim 2, wherein an composite power is the sum of the first motor power and the second motor power, and wherein the composite power is a minimum power for conveying the wire at the reference speed.

5. The method of claim 4, wherein the first motor power and the second motor power are substantially equal at the composite power.

6. The method of claim 2, further comprising:
changing the reference speed to a new reference speed;
comparing the wire speed to the new reference speed;
modifying at least one of the first motor power and the second motor power based at least in part on the difference between the wire speed and the new reference speed; and
adjusting at least one of the first motor power and the second motor power based at least in part on the difference between the wire speed and the new reference speed.

7. The method of claim 1, wherein the first motor is a push motor, and wherein the second motor is a pull motor.

8. The method of claim 1, wherein the first motor is operatively coupled to a wire feeder, and wherein the second motor is operatively coupled to a welding gun.

9. A method for controlling a push motor and a pull motor in a wire feeding system, comprising:
detecting a wire speed of a consumable electrode;
comparing the wire speed to a reference speed;
detecting a first motor power at which a first motor is operating;
detecting a second motor power at which a second motor is operating;
modifying at least one of the first motor power and the second motor power based at least in part on a difference between the wire speed and the reference speed to arrive at a optimized total power, wherein the optimized total power is the lowest sum of the first motor power and the second motor power that conveys the consumable electrode at the reference speed.

10. The method of claim 9, further comprising detecting a force threshold in the wire, wherein modifying at least one of the first motor power and the second motor power is further based at least in part on the detected force threshold, and wherein the optimized total power conveys the wire under normal forces.

11. The method of claim 9, further comprising applying a power bias to at least one of the first motor and the second motor.

12. The method of claim 9, wherein the first motor power and the second motor power are within a threshold power difference of one another to provide the optimized total power.

13. The method of claim 9, further comprising:
calculating an optimal first motor power for the first motor based at least in part on parameters for a welding operation; and
calculating an optimal second motor power for the second motor based at least in part on the parameters for the welding operation.

14. The method of claim 13, further comprising:
comparing the first motor power to the optimal first motor power to produce a first power comparison; and
comparing the second motor power to the optimal second motor power to produce a second power comparison, wherein modifying at least one of the first motor power and the second motor power is further based at least in part on one or more of the first power comparison and the second power comparison.

15. The method of claim 9, further comprising:
detecting a third motor power at which a third motor is operating;
modifying the third motor power based at least in part on the difference between the wire speed and the reference speed.

16. A controller for managing a push motor and a pull motor in a wire feeding system, comprising:
a push motor control module configured to manage power output of a push motor;
a pull motor control module configured to manage power output of a pull motor;
a wire speed module configured to receive a measured wire speed; and
an optimization module configured to manage the power output of at least the push motor and the pull motor to deliver a wire at a reference speed at an optimized first motor power and an optimized second motor power.

17. The controller of claim 16, further comprising:
a wire force module configured to detect at least one of tension or compression in the wire, wherein the optimization module is configured to manage the power output of at least the push motor and the pull motor additionally based at least in part on the at least one of tension or compression in the wire.

18. The controller of claim 16, wherein the optimized first motor power and the optimized second motor power are both within a power range based at least in part on a welding parameter.

19. The controller of claim 16, further comprising a change module configured to receive a change to at least one welding parameter, wherein the optimization module is configured to manage the power output of at least the push motor and the pull motor additionally based at least in part on the change to the at least one welding parameter.

20. The controller of claim 16, wherein the optimization module is configured to cause the push motor and pull motor to operate at a lowest total system power.
